(19) United States
(12) Patent Application Publication
(10) Pub. No.: US 2012/0151863 A1
(43) Pub. Date: Jun. 21, 2012

(54) Wooden structural building panels

(76) Inventor: Kelly J. Smith, Anson, ME (US)

(21) Appl. No.: 12/928,550

(22) Filed: Dec. 15, 2010

(51) Int. Cl. E04C 2/30; B32B 15/00

(52) U.S. Cl. 52/578; 428/464

(57) ABSTRACT

This invention is based on sizes and shapes of wooden building panels that creates a standard of measurement for wooden stick built panels to increase efficiency in design, manufacturing, cost control and assembly.

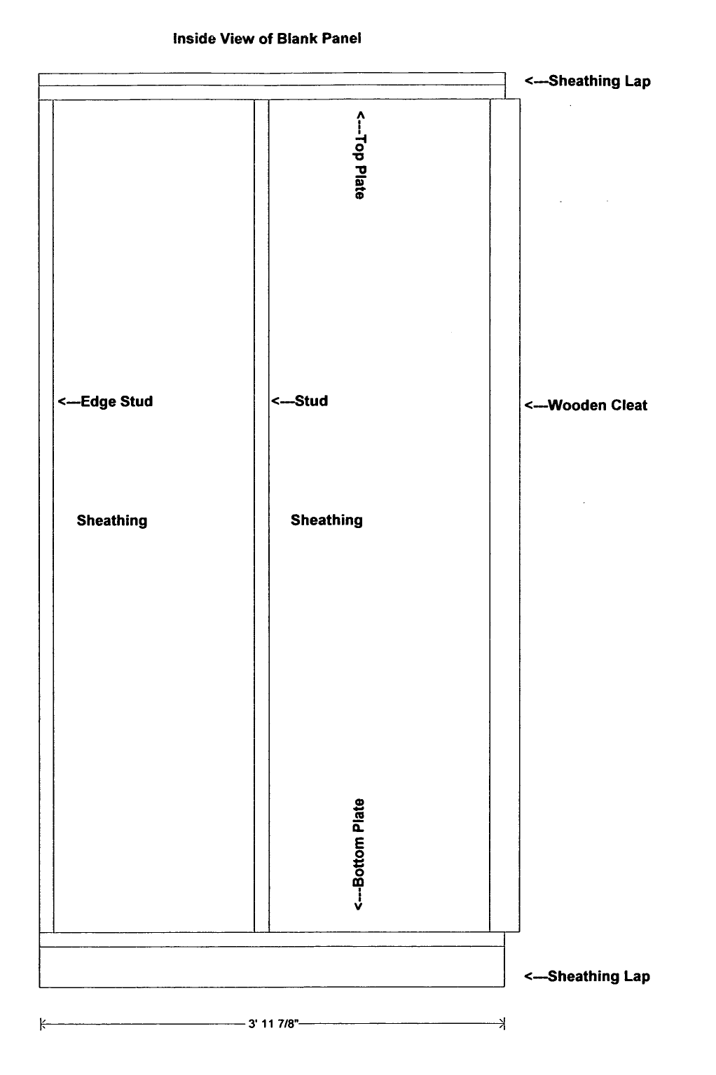

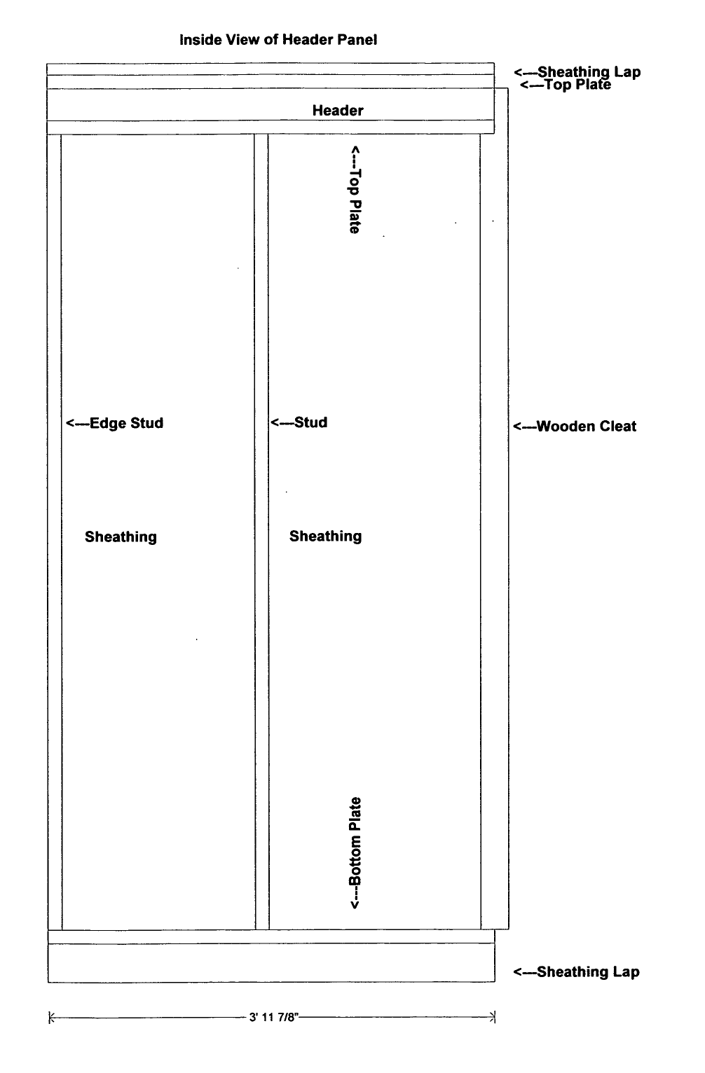

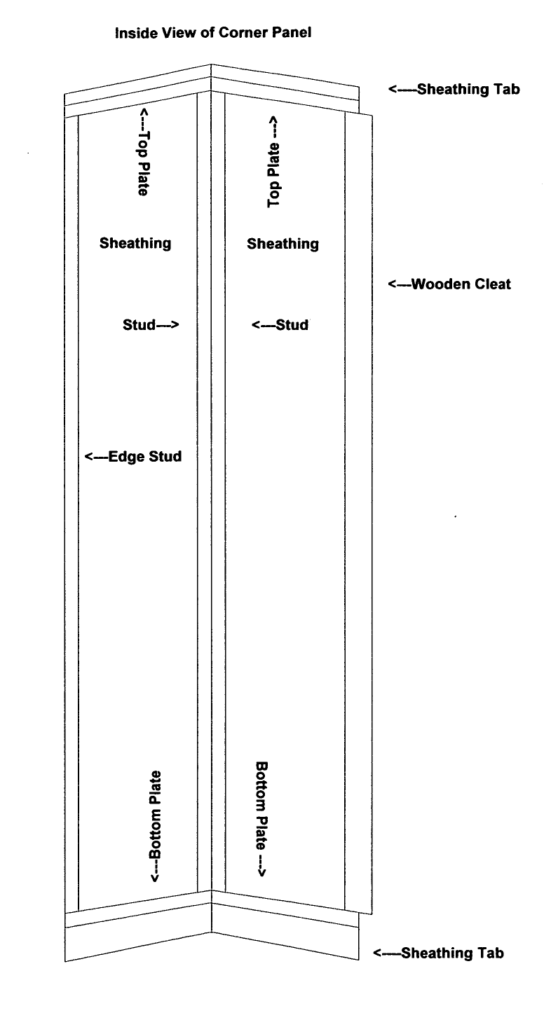

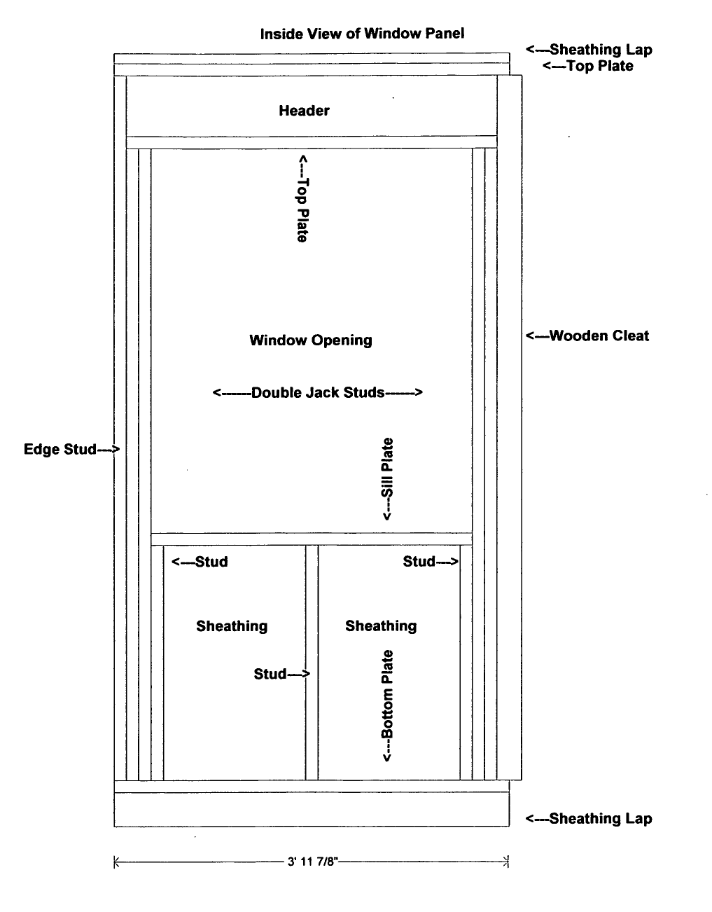

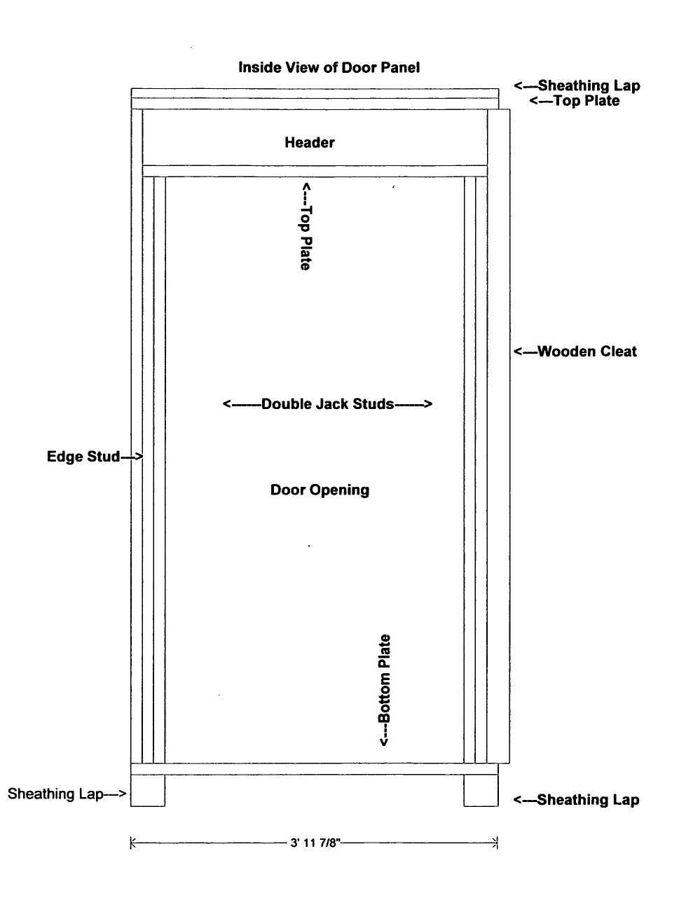

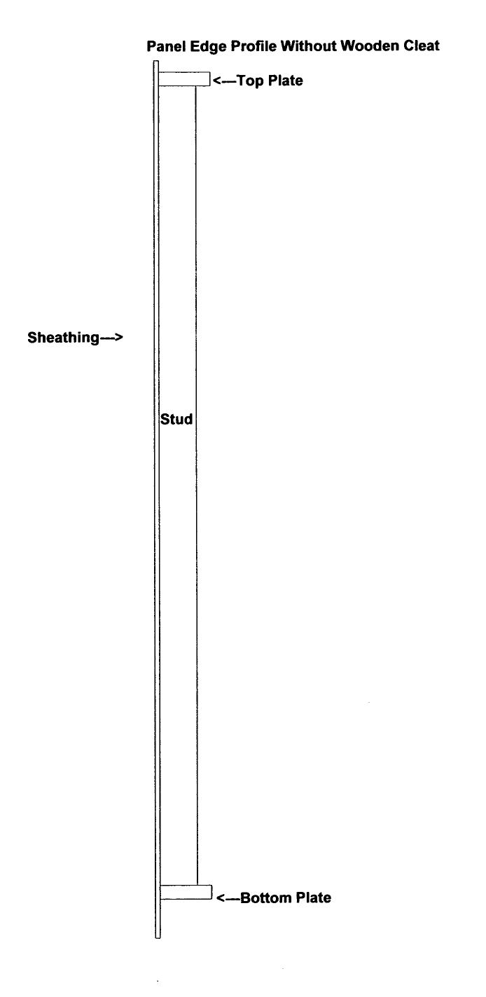

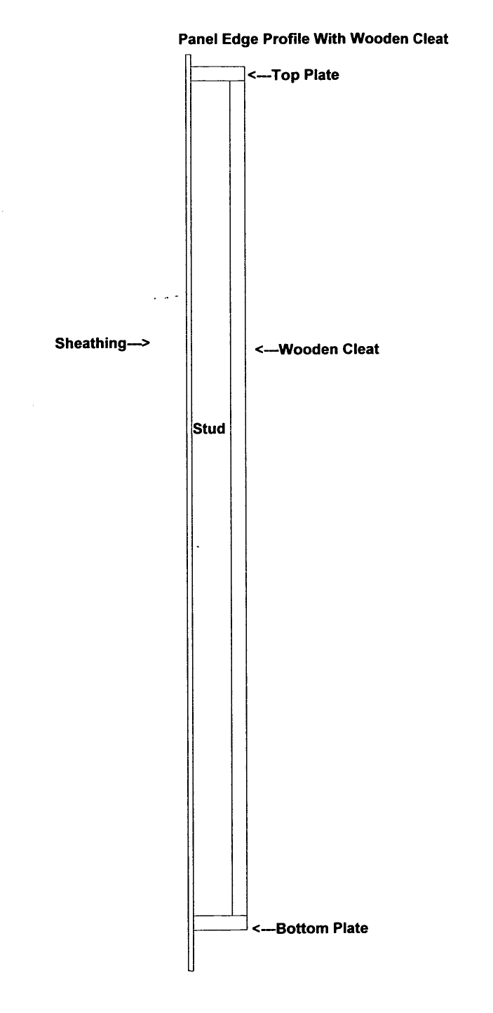

The corner panels have a 20 gauge galvanized metal plate that is sandwiched between the studs, top and bottom plates to complete structural soundness and maintain shape during storage, transport and assembly.

Panels are joined with 20 gauge galvanized metal plates at first top plate to complete structural soundness and wooden cleats at vertical edge studs that allows for easier assembly and an even surface for interior wall covering installation.

This invention is composite wooden building panels in a variety of standard shapes and sizes that make for many possible configurations of exterior wall structures.

Each panel in and of itself has all the components to be structural and support a second floor, ceiling and roof up to 36′ wide with a clear span except for 2×4 studded panels that are 24″ on center will only support 1 ceiling and roof 36′ wide by International Building Code standards.

The panels are of a small enough size that it is possible for 1 person with some general abilities to be able to construct the exterior walls of a custom designed building in a quick and efficient manner.

The panels being of standard sizes could be mass produced for distribution by specialty dealers or home improvement centers alike.

The use of these panels assist in quality control of code adherence due to the fact that they are a quality controlled product and not just raw materials delivered to a job site.

I reference the building frenzy that took place in Florida in the 1980's.

It was discovered after many houses were destroyed by hurricane that builders had done such things as only using as little as 8 nails per sheet of wall sheathing.

Such a thing would not occur with this panel system.

The panels would arrive with the majority of nailing already completed.

This will cut down on the amount of inspection time required for a quality job by only having a few critical areas to check.

A building shell could be assembled quite quickly and inspection coordinated more effectively due to the fact that typical house walls could be assembled in 1 day.

Furthermore, Building inspectors would not have to rely on trust or be onsite as much to keep such shoddy workmanship from happening as did in Florida.

Panels will have assigned numbers as to coordinate between different facilities manufacturing and/or stocking them.

Also, these panels can be mass produced for shipment into areas that have had a natural disaster come upon them and materials and labor are short at hand.

Ideally the panel parts would be produced close to areas that mill the raw materials so as to spread out the labor involved in construction and utilize the savings on shipping on the materials end.

The basic types of panels are; blank wall panel, window wall panel, door wall panel, header wall panel, outside corner wall panel and inside corner wall panel.

### Blank Wall Panel

### Claim: 1,2,4,5

Blank wall panel is framed in the typical stick framing method including sheathing.

The 48″panel is made 47⅞″ wide(panels being ⅛″ smaller in width for expansion) and can vary in height up to 9′ 10½″ from bottom of shoe plate to top of first top plate.

Vertical studs may be 16″ or 24″ on center with a vertical stud at either edge.

The edge studs are ripped down to a width to accept a wooden cleat .

### EXAMPLE

A standard 2″×6″ stud would have 1½″ ripped off the widest surface and 2″×4″ stud would have 3/4″ ripped off the widest surface

Wooden cleat would be 3/4″ and 1½″ thick respectively at a width of 3″

Cleat is to attach panels and provide a flat surface for application of interior finish such as drywall.

Top plate and bottom plate are of standard dimensional lumber same as the vertical studs.

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Window Wall Panel

### Claim: 1,2,4,5

Window wall panel is framed using typical stick framing method including sheathing.

The 48″panel is made 47⅞″ wide(panels being ⅛″ smaller in width for expansion) and can vary in height up to 9′ 10½″ from bottom of shoe plate to top of first top plate. Studs may be 16″ or 24″ on center with a vertical stud at either edge.

Edge studs will run from bottom plate to top plate with header fastened between.

The edge studs are ripped down to a width to accept a wooden cleat.

### EXAMPLE

A standard 2″×6″ stud would have 1½″ ripped off the widest surface and 2″×4″ stud would have ¾″ ripped off the widest surface

Wooden cleat would be ¾″ and 1½″ thick respectively at a width of 3″

Cleat is to provide a flat surface for application of interior finish such as drywall.

Top plate and bottom plate are of standard dimensional lumber same as the vertical studs.

Headers are made of double 2″×8″ standard dimensional lumber.

Headers have a top and bottom plate standard dimensional lumber same as the vertical studs.

Header top plate is also the panel top plate.

Sills have a double plate standard dimensional lumber same as the vertical studs.

Double jack studs are also used to support header, standard dimensional lumber same as the vertical studs.

Maximum window width rough opening is 38¾″ with double jack studs.

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Filler Wall Panel

### Claim: 1,2,4,5

Filler wall panel is framed using typical stick framing method including sheathing.

With a vertical stud at either edge of panel.

The edge studs are ripped down to a width to accept a wooden cleat.

### EXAMPLE

A standard 2″×6″ stud would have 1½″ ripped off the widest surface and 2″×4″ stud would have ¾″ ripped off the widest surface

Wooden cleat would be ¾″ and 1½″ thick respectively at a width of 3″

Cleat is to provide a flat surface for application of interior finish such as drywall.

Top plate and bottom plate are of standard dimensional lumber same as the vertical studs.

Panels are made in widths that are ⅛″ smaller than opening they will fill. (panels being ⅛″ smaller in width for expansion)

Panels can vary in height up to 9′ 10½″ from bottom of shoe plate to top of first top plate.

Top plate and bottom plate are of standard dimensional lumber same as the vertical studs.

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Door Wall Panel

### Claim: 1,2,4,5

Door wall panel is framed using typical stick framing method including sheathing.

Panel is built for rough opening for standard 36″ exterior door.

The 48″panel is made 47⅞″ wide(panels being ⅛″ smaller in width for expansion) and can vary in height up to 9′ 10½″ from bottom of shoe plate to top of first top plate. Studs may be 16″ or 24″ on center with a vertical stud at either edge of panel.

Edge studs will run from bottom plate to top plate with header fastened between.

The edge studs are ripped down to a width to accept a wooden cleat.

### EXAMPLE

A standard 2″×6″ stud would have 1½″ ripped off the widest surface and 2″×4″ stud would have ¾″ ripped off the widest surface

Wooden cleat would be ¾″ and 1½″ thick respectively at a width of 3″

Cleat is to provide a flat surface for application of interior finish such as drywall.

Headers are made of double 2″×8″ standard dimensional lumber.

Headers have a top and bottom plate of standard dimensional lumber same as the vertical studs. (Except for 90″ height panels).

Header top plate is also the panel top plate.

Bottom plate will be made of laminated plywood due to the small size and the nature of dimensional lumber to split.

Bottom plate will extend the full width of panel 47⅞″ and the middle portion cut off after placement. (for stability during handling).

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Header Wall Panel

### Claim: 1,2,4,5

(Header wall panel is for adding support in areas that the floor joists, ceiling joists or rafters do not line up with the wall studs)

Header wall panel is framed using typical stick framing method including sheathing.

The panel is made a minimum width of 2⅞″ wide and wider (with the minimum width each stud must have 1/16′ planed off thickness) , can vary in height up to 9′ 10½″ from bottom of shoe plate to top of first top plate.

With a vertical stud at either edge.

Edge studs will run from bottom plate to top plate with header fastened between.

The edge studs are ripped down to a width to accept a wooden cleat.

### EXAMPLE

A standard 2″×6″ stud would have 1½″ ripped off the widest surface and 2″×4″ stud would have ¾″ ripped off the widest surface

Wooden cleat would be ¾″ and 1½″ thick respectively at a width of 3″

Cleat is to provide a flat surface for application of interior finish such as drywall.

Top plate, bottom plate and jack studs are of standard dimensional lumber same as the vertical studs.

Headers are made of double 2″×4″ standard dimensional lumber.

Headers not needed until panel is 3⅞″ or wider

Headers have a top and bottom plate standard dimensional lumber same as the vertical studs.

Header top plate is also the panel top plate.

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Outside Or Inside Corner Wall Panel

### Claim: 1,2,3,4,5

Outside or inside corner wall panel is framed using typical stick framing method including sheathing.

Panel can vary in height up to 9′ 10½″ from bottom of shoe plate to top of first top plate

With a vertical stud at either edge of panel.

The edge studs are ripped down to a width to accept a wooden cleat.

### EXAMPLE

A standard 2″×6″ stud would have 1½″ ripped off the widest surface and 2″×4″ stud would have ¾″ ripped off the widest surface

Wooden cleat would be ¾″ and 1½″ thick respectively at a width of 3″

Cleat is to provide a flat surface for application of interior finish such as drywall.

Corner wall panels will be made at 90 degree, 45 degree, 30 degree and 22½ degree angles.

These different angles will make 4, 8, 12 and 16 sided structures respectively.

Or can be mingled within a given design to achieve many diverse shapes.

Such as adding a 5, 7 or 9 sided bumpout on a rectangle building like a victorian design.

The top and bottom plates are made of the respective size stud and mitered and joined with structural adhesive at the corners.

A metal plate of 20 gauge galvanized metal is attached with 1¼″ nails to plates prior to studs being added.

Metal plate size conforms to International Builder Code exemption for single top plate installation.

### (See Attached Drawing)

The outside perimeter of drawing is the size and shape of 20 gauge galvanized steel plate respective of the angle of corner and width of studs used. The inner lines of drawing is a basic layout of the corner stud ends.

The dots in drawing is where the nails go thru galvanized steel plates to connect studs, wood top plate, wood shoe plate. Galvanized steel plate is sandwiched between studs and wood plates.

Other forms of stick built panels are large in size and have to be custom designed and built.

The panels of this invention are of a size that can be handled by 1 person and being of standard sizes provide templates to create custom designs from.

See attached panel size lists for basic example.

Other panel manufacturers provide a very limited amount of building designs to choose from.

This invention allows for custom designs to be created almost equal to that of building with raw materials without the same skill level needed to build.

There can be difficulties in finding skilled carpenters to build quality stick built buildings especially when jobs are plentiful.

This invention requires less skill to assemble than a traditional stick built building therefor expanding the amount of possible qualified workers in a given area.

### Holes For Electrical Wires

All vertical studs will have a hole drilled in them at top and bottom.

⅞″ diameter holes at least 3″ away from ends of studs and 16″ for corner panel studs—(To accommodate blocking).

Holes will be centered and no holes in the header areas of 2×4 stud walls or in door opening studs.

### Dimensional Lumber

Dimensional lumber will have a quality and size equal too or greater than the International Building Code.

### Sheathing

Sheathing shall be extended 1¼″ above the top plate of panel to accommodate a second top plate.

And 4¾″ of sheet overhanging bottom.

Door and window openings may be left covered with sheathing(to be cut out by consumer as doors and windows are installed).

Sheathing will have a quality equal too or greater than the International Building Code.

Sheathing may also be coated with a waterproof or vapor barrier type coating.

Fastening Schedule

Fasteners; whether nails, screws, bolts or structural adhesives are used, will have a quality equal too or greater than any building codes where panels are intended to be used.

Fastening schedule will also be equal too or better than the International Building Code.

### Assembly

Layout of panels shall be done in advance of assembly.

Along all sides of floor, a chalkline is made where interior of panels will land.

Starting from a corner measure and make a pencil mark where each panel will be placed.

The marks will be based on a rounded up size of each panel.

### Example

11⅞″=12″, 15⅞″=16″, 23⅞″=24″, 47⅞″=48″

Install first panel away from corner panel and brace it to keep plumb.

Start placing panels making sure each panel is plumb all directions (forwards and backwards, side to side) and braced as you go.

Cleats may be used at this time to start securing panels.

Metal splicing plates of 20 gauge galvanized steel that are 8″ long and 3″ or 5″ wide with respect to top plate width shall be placed at every panel intersection along first top plate. Use nailing, screwing or bolting schedules as local building codes apply for each area.

Also the second top plate may be added as soon as possible.

Second top plates may consist of longer studs such as 8′, 12′ or 16′ in length.

Then nail top and bottom edge of sheathing using nailing schedules as local building codes apply for each area.

1: Panels are of sizes and configurations that as little as 1 person with minimal construction knowledge can put up exterior walls of a building of custom design efficiently. (All the most difficult angles and measurements already being completed).

2: Panels have a wooden cleat used to aid in assembly and provide a flat surface for application of interior wall covering. (e.g., Drywall)

3: Corner panels have top and bottom plates made of wood and metal to maintain shape during storage and handling.

4: Panels are made in widths that allow for easy assembly with consideration for expansion during storage.

5: Panels having standard sizes (panels will be identified by standard numbers) will make for easier design, estimation, cost control and quality control of a custom building project.
